(19) United States
(12) Patent Application Publication
(10) Pub. No.: US 2013/0117460 A1
(43) Pub. Date: May 9, 2013

(54) DATA MANAGEMENT METHODS FOR USE IN A NETWORK SYSTEM AND NETWORK SYSTEMS USING THE SAME

(71) Applicants: HSUEH-CHENG HSU, Kuei Shan Hsiang (TW); TSAI-MU CHEN, Kuei Shan Hsiang (TW); CHUN-YU LIN, Kuei Shan Hsiang (TW)

(72) Inventors: HSUEH-CHENG HSU, Kuei Shan Hsiang (TW); TSAI-MU CHEN, Kuei Shan Hsiang (TW); CHUN-YU LIN, Kuei Shan Hsiang (TW)

(73) Assignee: QUANTA COMPUTER INC., Kuei Shan Hsiang (TW)

(21) Appl. No.: 13/469,767

(22) Filed: May 11, 2012

(30) Foreign Application Priority Data
Nov. 9, 2011 (TW) 100140853

(51) Int. Cl. G06F 15/16

(52) U.S. Cl. 709/228

(57) ABSTRACT

Data management methods for use in a network system including at least first, second and third network terminal devices and traversal server are disclosed. First and second network terminal devices can traverse at least one NAT router and/or firewall to establish a connection channel between each other for data access through traversal server. The method includes the steps of: receiving first packet with first protocol format from first network terminal device; determining whether to perform protocol conversion operation; if so, obtaining a list of available network terminal devices, assigning first network terminal device from obtained list, converting first packet with first protocol format into second packet with second protocol format that is decodable by second network terminal device, and sending second packet to second network terminal device such that second network terminal device can obtain content of first packet by decoding second packet upon reception of second packet.

### CROSS REFERENCE TO RELATED APPLICATIONS

This Application claims priority of Taiwan Patent Application No. 100140853, filed on Nov. 9, 2011, the entirety of which is incorporated by reference herein.

### BACKGROUND OF THE INVENTION

1. Field of the Invention

The invention relates to data management methods of network systems, and more particularly, to methods for managing data among network terminal devices with various packet protocols formats capable of traversing NAT routers and firewalls.

2. Description of the Related Art

Recently, due to the vigorous development and popularity of network applications, bandwidth increase and progress of voice compression technology of network, and rapid development of Voice over IP (VoIP) technology, Internet users can transmit real-time voice and images and other multimedia information. When using VoIP, both ends of the receiver and the speaker must be filled in with the respective computer's IP address to enable the connection between the two parties. However, the real network may have various types of Firewalls and network address translators (hereinafter referred to as NAT). When the network terminal device is located behind the Firewall or NAT, e.g., for the user who uses dial-up or ADSL equipment to access Internet at home or is located behind the Firewall, direct normal communication between network terminal devices is impossible because of the difficulty of finding the external IP address, causing great inconvenience to the user.

In order to solve these problems, the VoIP traverse network address translation router (hereinafter referred to as NAT router) and Firewall-related technologies were then extensively studied. Through VoIP traverses NAT and Firewall technologies, VoIP can still run smoothly even if the user is behind a NAT router and/or Firewall. NAT is a kind of technology that inter-converts the internal IP address and external IP address. The NAT aims to provide function to visit the external network to the computer that was using the intranet IP address, through a few sets of computers that have the public IP address of the public network. The NAT converts the IP address of the IP datagram source that was issued to the external network by the computers of some intranet IP addresses into the IP address of the NAT's own public network. The destination IP address remains unchanged, and the IP datagram is transferred to the router and finally to the external computer. At the same time, the NAT converts the destination IP address of the external computer's returned IP datagram to the intranet IP address, while the source IP address remains unchanged, and is eventually sent to the computer of the internal network. Among them, the best-known and most commonly used VoIP traverses NAT router and Firewall solution was called Simple Traversal of UDP (User datagram protocol) through NAT (referred to as STUN) or Traversal Using Relay NAT (referred to as TURN). STUN uses the server located on the Internet to help network terminal device in the Firewall to obtain their external address transformed by the NAT and to assist VoIP call of other users to traverse through the Firewall to send to the network terminal device in the firewall. Through the STUN server, the client terminal device can determine the public address, the type of NAT blocked in front, and the connection port to connect with a particular local port through the NAT. This information will be used to establish a UDP communication between the client terminal device and the VoIP service providers to achieve the VoIP call. When the TURN server receives a packet, the TURN server will store the IP address and port of the packet source and then forward the request of the proposed address to the other party. The TURN server then acts as a forwarder between the two addresses. Any information received from the first address may be provided to the second address, and any information received from the second address may be provided to the first.

Although the aforementioned use of STUN/TURN technology may traverse through the Firewall, as not all network terminal devices have the ability to traverse through the NAT router and/or Firewall, when the network terminal device at the sender end using VoIP traverses the NAT and Firewall technologies to pack the UDP packets into packets with a special format and send to the network terminal device of the receiving end, the network terminal device of the receiving end may not be able to directly interpret the transmitted packets, leading to failure to access the information transmitted and establish a connection. For example, when the network terminal device of the sender packs the UDP packets to be sent into the HTTP/HTTPS packets and sent them to the network terminal device of the receiving end, the network terminal device of the receiving end may not be able to directly interpret the HTTP/HTTPS packets, resulting in failure to access the information transmitted and establish a connection. In addition, for network terminal device based on H.323, the session initiation protocol (referred to as SIP) and other standard applications use the UDP datagram to transmit the audio and/or video data on the Internet. However, the real media connection information is transferred on the datagram payload, as the two network terminal devices may be located behind a NAT, the establishment of a connection may be failed. Therefore, packets conversion in protocol format are required to be performed through a protocol conversion server at the network end, to convert HTTP/HTTPS packets that sent by the sender network terminal device to specific format packets that can be decoded and received by the network terminal device of the receiving end. Subsequently, the specific format packets sent by the network terminal device of the receiving end may also be converted through the protocol conversion server at the network end to the packet format that can be decoded by the sender network terminal device.

As the aforementioned protocol conversion server is usually set in the remote end and must simultaneously perform considerable protocol conversion operation from multiple network terminal devices, the routing path through the server is usually longer, causing the delay of transmission, packet loss, and failure in a timely process.

It is therefore a desire to provide data management methods for managing data transmitted among the network terminal devices that are located behind or outside the NAT router and firewall to solve the aforementioned problems.

### BRIEF SUMMARY OF THE INVENTION

Data management methods for use in a network system and network systems using the same are provided.

An embodiment of a data management method for use in a network system is provided, wherein the network system includes at least first, second and third network terminal devices and a traversal server and the first and second network terminal devices can traverse at least one NAT router and/or firewall to establish a connection channel between each other for data access through the traversal server. The method comprises the steps of receiving a first packet with a first protocol format from the first network terminal device, determining whether to perform a protocol conversion operation, when determining to perform the protocol conversion operation, obtaining a list of available network terminal devices and assigning a third network terminal device from the list of available network terminal devices, converting the first packet with the first protocol format from the first network terminal device into a second packet with a second protocol format that is decodable by the second network terminal device, and sending the second packet to the second network terminal device such that the second network terminal device decodes the second packet to obtain the content of the first packet upon reception of the second packet.

An embodiment of a network system is also provided. The network system comprises at least first, second and third network terminal devices and a traversal server. The first and second network terminal devices can traverse at least one NAT router and/or firewall to establish a connection channel between each other for data access through the traversal server. Wherein, the traversal server receives a first packet with a first protocol format from the first network terminal device, determines whether to perform a protocol conversion operation and when determining to perform the protocol conversion operation, obtains a list of available network terminal devices and assigns a third network terminal device from the list of available network terminal devices, converts the first packet with the first protocol format from the first network terminal device into a second packet with a second protocol format that is decodable by the second network terminal device, and sends the second packet to the second network terminal device such that the second network terminal device decodes the second packet to obtain the content of the first packet upon reception of the second packet.

Data management methods for use in a network system may take the form of a program code embodied in a tangible media. When the program code is loaded into and executed by a machine, the machine becomes an apparatus for practicing the disclosed method.

### BRIEF DESCRIPTION OF THE DRAWINGS

The invention can be more fully understood by reading the subsequent detailed description and examples with reference to the accompanying drawings, wherein:

FIG. 1 shows a block diagram of an embodiment of a network system according to the invention; and

FIG. 2 is a flowchart illustrating an embodiment of a data management method for use in a network system according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

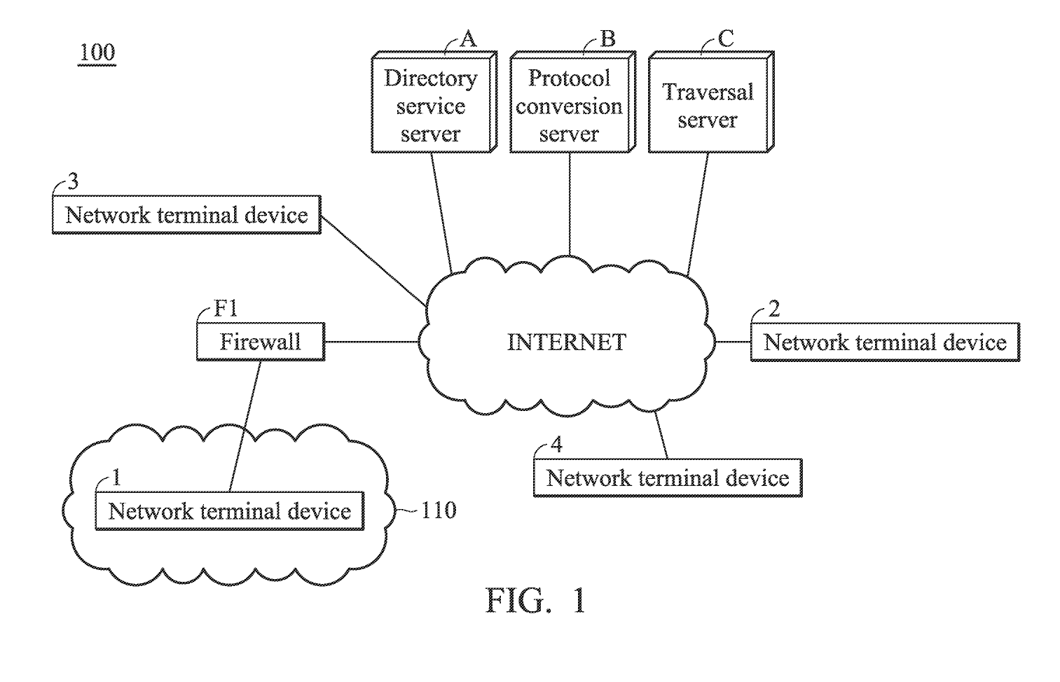

FIG. 1 shows a block diagram of an embodiment of a network system 100 according to the invention. The network system 100 at least comprises first, second and third network terminal devices 1-4, a directory service server A, a protocol conversion server B and a traversal server C and the first and second network terminal devices may traverse at least one NAT router and/or firewall to establish a connection channel between each other for accessing data between the first and second network terminal devices. The first, the second or the third network terminal device may be any of the network terminal devices 1-4. For example, the first, second and third network terminal devices may be the network terminal devices 1, 2 and 3, respectively. To be more specific, the traversal server C can be referred to as a NAT/firewall traversal server and can be a STUN/TURN server or a HTTP/HTTPS tunneling server such that a network terminal device that is located within/behind an NAT router and/or a firewall may establish a connection channel with another network terminal device that is located within or out of an NAT router and/or a firewall for data access between each other. With the STUN/TURN server, the network terminal device of the user may find information regarding its public network address such as the Internet address, the type of the NAT that it is currently located and so on and then establishes an UDP communication to accomplish a network communication link using these information or the network terminal device of the user may utilize the STUN/TURN server as a forwarder of the two addresses to obtain its network address so as to establish the desired connection. With the HTTP/HTTPS tunneling server, the network terminal device of the user within the firewall may pack the UDP packet into a HTTP/HTTPS packet using the HTTP/HTTPS tunneling and then traverse the firewall by sending this packet to the network terminal device of another user that is located outside the firewall via the common HTTP/HTTPS port 80/443. When the first network terminal device is connected to the Internet through a firewall F1, the traversal server C is a HTTP/HTTPS tunneling server and the first network terminal devices may traverse through the firewall F1 using the HTTP/HTTPS tunneling via the HTTP/HTTPS tunneling server to establish a connection channel with the second network terminal device so as to transmit data therebetween.

The directory service server A is a public server located on the Internet and it may provide directory service which records a mapping table of user names/code numbers and responsive IP address and connection com port information for all registered network terminal devices in the network system 100. For example, when the user “John” attempts to call the other user “Mary” to make a VoIP call, the IP address and connection port information of the “John” and “Mary” may first be acquired from the directory service server A by table lookup and then the traversal server C may arrange a routing path for connection using the information acquired from the directory service server A, e.g. information regarding the IP address and connection port, packet data format and so on. In addition, the directory service server A may also record an on-line user list for recording users that are currently on-line for subsequent process.

When two network terminal devices attempt to perform a data transmission operation, the traversal server C may further determine whether to perform a protocol conversion operation to exchange the packet data formats for the these two network terminal devices through the protocol conversion server B according to data formats used by the these two network terminal devices, such as exchange between the SIP/H.323 format and the HTTP/HTTPS format. In some embodiments, the protocol conversion server B can be a SIP-HTTP/HTTPS protocol converter to perform a packet data format exchange between the SIP/H.323 format and the HTTP/HTTPS format, that is, to convert a packet with the SIP/H.323 format to a packet with the HTTP/HTTPS format or to convert a packet with the HTTP/HTTPS format to a packet with the SIP/H.323 format. When the two network terminal devices use a same packet data format, the traversal server C may directly use the packets sent by the two network terminal devices to perform the data transmission operation while the traversal server C may perform the protocol conversion operation to the two network terminal devices to exchange packet data formats therebetween through the protocol conversion server B when the two network terminal devices use different packet data formats. The data management methods for use in a network system are detailed in the following.

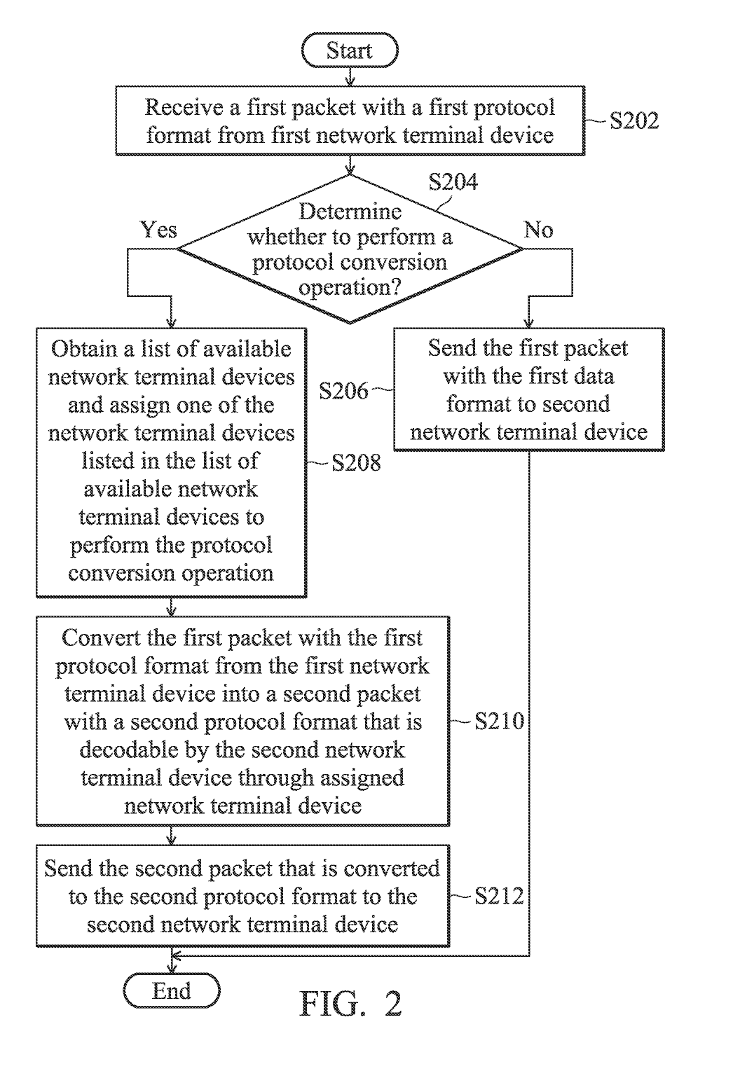

FIG. 2 is a flowchart illustrating an embodiment of a data management method for use in a network system according to the invention for traversing through the firewall to transmit data among network terminal devices. Please refer to both FIGS. 1 and 2. In this embodiment, it is assumed that the network system 100 comprises at least a first network terminal device 1, a second network terminal device 2 and a third network terminal device 3, the directory service server A and the traversal server C and the network terminal device 1 and the network terminal device 2 can traverse through at least one NAT router and/or firewall to establish a connection channel between each other for data access through the traversal server C. Moreover, it is also assumed that the network terminal device 1 is located within the firewall F1 and the network terminal device 1 uses a packet compatible with a first protocol format for data transmission, wherein the network terminal device 1 may pack the UDP packet into a HTTP/HTTPS packet using the HTTP/HTTPS tunneling and then send this packet via the common HTTP/HTTPS port 80/443 to traverse through the firewall to establish a connection to the traversal server C.

When the network terminal device 1 attempts to establish a connection to the network terminal device 2 to perform a network application, such as video conferencing or VoIP/V²oIP call, the network terminal device 1 sends a VoIP call request to the directory service server A. The directory service server A then finds IP addresses and responsive connection ports and utilized packet data formats for a source user and a destination user indicated by the VoIP call request according to the user identification code of the source user and the identification code of the destination user included in the VoIP call request and then transmits the found information to the traversal server C. For example, when the user “Jason” attempts to call the other user “John” to make a VoIP call, the directory service server A may find information regarding the IP address and connection port, packet data format and so on of the “Jason” and “John” by table lookup and then transmits those found information to the traversal server C.

First, when the traversal server C receives a first packet with a first protocol format from the first network terminal device 1 (step S202), the traversal server C determines whether to perform a protocol conversion operation (step S204). The traversal server C may obtain information regarding the packet data formats that are used by the network terminal device 1 and network terminal device 2, respectively, based on the information found by the directory service server A to determine whether to perform the protocol conversion operation. When the packet data format used by the network terminal device 1 is the same as that used by the network terminal device 2 (e.g. both are used HTTP/HTTPS packets), which indicates that no protocol conversion is required (No in step S204) and thus step S206 is further performed to directly send the first packet with the first data format to the network terminal device 2. After the network terminal device 2 has received the first packet, it may decode the first packet to obtain the content of the packet by the same first protocol directly and later the network terminal device 2 may further send another packet with the first protocol format to the traversal server C so as to transmit it to the network terminal device 1 through the traversal server C.

Contrarily, when the packet data format used by the network terminal device 1 is different from that used by the network terminal device 2 (e.g. one used HTTP/HTTPS packets while the other used UDP packet compatible with the SIP format), which indicates that protocol conversion is required (Yes in step S204) and thus steps S208-S212 are further performed to select the network terminal device to perform the protocol conversion operation.

When determining to perform the protocol conversion operation, in step S208, the traversal server C obtains a list of available network terminal devices from the directory service server A and assigns one of the network terminal devices listed in the list of available network terminal devices to perform the protocol conversion operation. As previously described, the directory service server A may record an on-line user list for recording users that are currently on-line and thus which users are currently on-line can be known thereby so that the traversal server C may obtain this on-line user list from the directory service server A to obtain the list of available network terminal devices and assign one of the network terminal devices listed in the list of available network terminal devices to perform the protocol conversion operation. In this embodiment, each network terminal device in the list of available network terminal devices may both have original terminal device function to act as a terminal device and a proxy server function to substitute for the protocol conversion server, wherein the original terminal device function is enabled while the proxy server function to substitute for the protocol conversion server is disabled at initial. The traversal server C determines whether to perform a protocol conversion operation according to packet data formats used at both the transmission end and the receiving end, and if so, selects one of the network terminal devices listed in the list of available network terminal devices to act as the proxy server to substitute for the protocol conversion server. In some embodiments, the selected network terminal device in the list of available network terminal devices can be determined based on the network topology levels and positions for both network terminal devices at the transmission end and at the receiving end, e.g. a network terminal device that is neighboring to both network terminal devices at the transmission end and at the receiving end can be selected and assigned as the selected network terminal device to perform the protocol conversion operation.

Thereafter, the traversal server C converts the first packet with the first protocol format from the first network terminal device 1 into a second packet with a second protocol format that is decodable by the second network terminal device 2 via the assigned network terminal device (step S210). Note that the traversal server C may select a network terminal device to perform the protocol conversion operation by enabling the proxy server function for substituting for the protocol conversion server of that network terminal device . After the proxy server function for substituting for the protocol conversion server of any network terminal device has been enabled, the network terminal device will have both the terminal device functionality and the proxy server function to substitute for the assigned protocol conversion server. For example, if the traversal server C assigns the network terminal device 3 to be the proxy server of the protocol conversion server, the proxy server function of the network terminal device 3 will be enabled to be used as a normal protocol conversion server to convert the first packet with the first protocol format (e.g. the HTTP/HTTPS packet compatible with the HTTP/HTTPS format) to a second packet with a second protocol format that can be decoded by the second network terminal device 2 (e.g. the UDP packet compatible with the SIP/H.323 format). Thereafter, the traversal server C or the network terminal device 3 may send the second packet that is converted to the second protocol format to the second network terminal device 2 such that the network terminal device 2 may receive the second packet and then decode the second packet by the second protocol to obtain the content of the second packet upon reception of the second packet (step S212). Similarly, upon reception of the second packet with the second protocol format from the network terminal device 2, the traversal server C may convert the received second packet with the second protocol format to a third packet with the first protocol format that can be decoded by the first network terminal device 1 via the assigned network terminal device 3 such that the network terminal device 1 may receive the third packet and then decode the third packet by the first protocol to obtain the content of the third packet. It is to be understood that although the network terminal device 3 should act as a proxy server to substitute for the functionalities of the protocol conversion server, it only requires to handle the protocol conversion operations of a few network terminal devices, thus increasing only few overhead of the network terminal device 3 and making easy in implementation. In some embodiments, as shown in FIG. 1, if the network terminal device 3 is busy, the traversal server C may select other free network terminal device 4 to substitute for the functionalities of the protocol conversion server.

For example, referring to FIG. 1, it is assumed that network terminal device 1 is located within the firewall F1 and the network terminal device 2, 3, 4 are located out of the firewall F1, wherein the network terminal device 2 only supports UDP packet with the protocol format compatible with SIP/H.323 protocol. When a communication connection between the network terminal devices 1 and 2 is to be established, the network terminal device 1 packs the SIP/H.323 packet to be sent into a HTTP/HTTPS packet and obtains information regarding the IP address, the connection port, the packet data format and other information of the network terminal device 2 from the directory service server A through the firewall F1. The directory service server A then informs the traversal server C and the traversal server C determines to perform a protocol conversion operation according to the packet data format information of the network terminal devices 1 and 2. Therefore, the traversal server C assigns/selects one of the network terminal devices (e.g. the network terminal device 3) listed in the list of available network terminal devices provided by the directory service server A and enables its proxy server function for substituting for the protocol conversion server to perform a protocol conversion operation. The traversal server C sends a message to the network terminal device 3 and upon reception of the message, the assigned network terminal device 3 enables its proxy server function for substituting for the protocol conversion server. By doing so, the network terminal device 3 may substitute for the protocol conversion server B to convert the first packet compatible with the HTTP/HTTPS format from the network terminal device 1 into a second packet with the SIP/H.323 format and then sends the second packet to the network terminal device 2 or convert the second packet compatible with the SIP/H.323 format from the network terminal device 2 into a third packet with the HTTP/HTTPS format and then sends the third packet to the network terminal device 1 such that the network terminal devices 1 and 2 can transmit data between each other through the network terminal device 3 located at the near end without through the protocol conversion server B located at the remote end.

In some embodiments, after the connection is terminated, the traversal server C may further disable the proxy server function which substitutes for the protocol conversion server of the third network terminal device to avoid unnecessary power consumption of the third network terminal device upon reception of a request for terminating connection from any network terminal device.

In summary, with the data management methods for use in a network system and related network systems of the invention, when the remote traversal server on the Internet is required to pass through the NAT router and Firewall for data transmission as the transmission between network terminal devices of the two different data format standards was blocked by the NAT router and Firewall, the remote penetration server can choose one of the available network terminal devices located at the near end to assist in the operation of protocol conversion, enabling the data transfer to be carried out smoothly between network terminal devices to provide a higher data transfer performance. In addition, through the network terminal device framework with the protocol conversion function provided by the invention, the proximal network terminal device can be assigned to perform the protocol conversion operation, rather than through a remote protocol conversion server, to reduce the considerable load of the remote conversion server, effectively reduce the chance of transmission delay and packet loss, thus providing a higher quality of video images.

Data management methods for use in a network system, or certain aspects or portions thereof, may take the form of a program code (i.e., executable instructions) embodied in tangible media, such as floppy diskettes, CD-ROMS, hard drives, or any other non-transitory machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded to the broadest interpretation so as to encompass all such modifications and similar arrangements.

What is claimed is:

1. A data management method for use in a network system, wherein the network system includes at least first, second and third network terminal devices and a traversal server and the first and second network terminal devices can traverse at least one NAT router and/or firewall to establish a connection channel between each other for data access through the traversal server, the method comprising:
receiving a first packet with a first protocol format from the first network terminal device;
determining whether to perform a protocol conversion operation;
when determining to perform the protocol conversion operation, obtaining a list of available network terminal devices and assigning a third network terminal device selected from the list of available network terminal devices;
converting the first packet with the first protocol format from the first network terminal device into a second packet with a second protocol format that is decodable by the second network terminal device; and
sending the second packet to the second network terminal device such that the second network terminal device decodes the second packet to obtain the content of the first packet upon reception of the second packet.

2. The data management method of claim 1, wherein the step of determining whether to perform the protocol conversion operation is performed by determining whether the first protocol format matches the second protocol format and the protocol conversion operation is determined as being performed when the first protocol format

3. The data management method of claim 1, further comprising:
directly sending the first packet to the second network terminal device when determining that the protocol conversion operation is not being performed.

4. The data management method of claim 1, further comprising:
converting a third packet with the second protocol format from the second network terminal device into a fourth packet with the first protocol format through the assigned third network terminal device; and
sending the fourth packet to the first network terminal device such that the first network terminal device decodes the fourth packet to obtain the content of the fourth packet upon reception of the fourth packet.

5. The data management method of claim 1, wherein the first protocol format comprises HTTP/HTTPS format and the second protocol format comprises SIP/H.323 format.

6. The data management method of claim 1, wherein the list of available network terminal devices is provided by a directory service server.

7. The data management method of claim 1, wherein the third network terminal device further includes a disabled proxy server function and the proxy server function of the third network terminal device is enabled to substitute for a remote protocol conversion server to perform the protocol conversion operation between the first network terminal device and the second network terminal device.

8. A network system, comprising:
at least first, second and third network terminal devices; and
a traversal server, wherein the first and second network terminal devices can traverse at least one NAT router and/or firewall to establish a connection channel between each other for data access through the traversal server,
wherein the traversal server receives a first packet with a first protocol format from the first network terminal device, determines whether to perform a protocol conversion operation and when determining to perform the protocol conversion operation, obtains a list of available network terminal devices and assigns a third network terminal device from the list of available network terminal devices, converts the first packet with the first protocol format from the first network terminal device into a second packet with a second protocol format that is decodable by the second network terminal device, and sends the second packet to the second network terminal device such that the second network terminal device decodes the second packet to obtain the content of the first packet upon reception of the second packet.

9. The network system of claim 8, wherein the traversal server further converts a third packet with the second protocol format from the second network terminal device into a fourth packet with the first protocol format through the assigned third network terminal device and sends the fourth packet to the first network terminal device such that the first network terminal device decodes the fourth packet to obtain the content of the fourth packet upon reception of the fourth packet.

10. The network system of claim 8, further comprising a directory service server for providing the list of available network terminal devices.
